(19) United States
(12) Patent Application Publication
(10) Pub. No.: US 2023/0153387 A1
(43) Pub. Date: May 18, 2023

(54) TRAINING METHOD FOR HUMAN BODY ATTRIBUTE DETECTION MODEL, ELECTRONIC DEVICE AND MEDIUM

(71) Applicant: BEIJING BAIDU NETCOM SCIENCE TECHNOLOGY CO., LTD., Beijing (CN)

(72) Inventors: Chao Li, Beijing (CN); Ying Xin, Beijing (CN); Yuan Feng, Beijing (CN); Bin Zhang, Beijing (CN); Yunhao Wang, Beijing (CN); Xiaodi Wang, Beijing (CN); Yi Gu, Beijing (CN); Xiang Long, Beijing (CN); Yan Peng, Beijing (CN); Honghui Zheng, Beijing (CN); Zhuang Jia, Beijing (CN); Shumin Han, Beijing (CN)

(73) Assignee: BEIJING BAIDU NETCOM SCIENCE TECHNOLOGY CO., LTD., Beijing (CN)

(21) Appl. No.: 18/150,964

(22) Filed: Jan. 6, 2023

Related U.S. Application Data
(63) Continuation of application No. PCT/CN22/75190, filed on Jan. 30, 2022.

(30) Foreign Application Priority Data
Apr. 27, 2021 (CN) 202110462302.0

(51) Int. Cl. G06F 18/214; G06V 10/25

(52) U.S. Cl. CPC G06F 18/214; G06V 10/25

(57) ABSTRACT

A training method for a human body attribute detection model includes: acquiring positive sample sub-images and negative sample sub-images respectively corresponding to a plurality of human body attribute categories; determining a plurality of first annotation attributes respectively corresponding to the plurality of positive sample sub-images; and a plurality of second annotation attributes respectively corresponding to the plurality of negative sample sub-images; and training an artificial intelligence model according to the plurality of positive sample sub-images, the plurality of negative sample sub-images, the plurality of first annotation attributes and the plurality of second annotation attributes to obtain the human body attribute detection model, so that the human body attribute detection model obtained by training can effectively model fine-grained attributes of the human body.

### CROSS-REFERENCE TO RELATED APPLICATION

This application is a continuation of International Application No. PCT/CN2022/075190, filed on Jan. 30, 2022, which was proposed based on a Chinese patent application with the application number of 202110462302.0 and the filing date of Apr. 27, 2021, and claims the priority of this Chinese patent application, the entire content of which is hereby incorporated by reference into the present disclosure.

### TECHNICAL FIELD

The present disclosure relates to the technical field of artificial intelligence, specifically to the technical fields of computer vision, deep learning, and the like, and can be applied to intelligent cloud and security inspection scenarios, in particular to a training method for a human body attribute detection model, an electronic device and a medium.

### BACKGROUND

Artificial intelligence is a discipline that studies enabling of computers to simulate certain thinking processes and intelligent behaviors (such as learning, reasoning, thinking, planning, etc.) of human, and relates to not only hardware-level technology but also software-level technology. Artificial intelligence hardware technology generally includes technologies such as sensors, dedicated artificial intelligence chips, cloud computing, distributed storage, big data processing, and the like; and artificial intelligence software technology mainly includes several major directions such as computer vision technology, speech recognition technology, natural language processing technology, and machine learning/deep learning, big data processing technology, knowledge graph technology, and the like.

Models used for human body attribute detection in the related art have a poor ability to express the features of the human body image used for recognition, thereby affecting accuracy of human body attribute detection.

### SUMMARY

According to a first aspect, a training method for a human body attribute detection model is provided, which includes:

acquiring a plurality of sample images respectively corresponding to a plurality of human body attribute categories;

detecting the plurality of sample images respectively to obtain a plurality of positive sample sub-images and a plurality of negative sample sub-images respectively corresponding to the plurality of human body attribute categories;

determining a plurality of first annotation attributes respectively corresponding to the plurality of positive sample sub-images according to the plurality of human body attribute categories;

determining a plurality of second annotation attributes respectively corresponding to the plurality of negative sample sub-images according to the plurality of human body attribute categories; and

training an initial artificial intelligence model according to the plurality of positive sample sub-images, the plurality of negative sample sub-images, the plurality of first annotation attributes and the plurality of second annotation attributes to obtain the human body attribute detection model.

According to a second aspect, a human body attribute recognition method is provided, which includes:

acquiring an image of the human body to be detected;

inputting the image of the human body to be detected into a human body attribute detection model obtained by training by the above described training method for the human body attribute detection model, so as to obtain a target human body attribute outputted by the human body attribute detection model.

According to a third aspect, an electronic device is provided, which includes:

at least one processor; and

a memory communicatively connected to the at least one processor; wherein

instructions executable by the at least one processor are stored in the memory, and the instructions are executed by the at least one processor, so that the at least one processor can execute the training method for a human body attribute detection model of embodiments of the present disclosure, or execute the human body attribute recognition method of embodiments of the present disclosure.

According to a fourth aspect, a non-transitory computer-readable storage medium storing computer instructions is proposed, the computer instructions are configured to cause the computer to execute the training method for a human body attribute detection model of embodiments of the present disclosure, or to execute the human body attribute recognition method of embodiments of the present disclosure.

It should be understood that what is described in the present section is not intended to identify key or important features of embodiments of the present disclosure, nor is it intended to limit the scope of the present disclosure. Other features of the present disclosure will be readily understood through the following description.

### BRIEF DESCRIPTION OF THE DRAWINGS

The accompanying drawings are used to better understand the present solution, and do not constitute a limitation to the present disclosure, in which:

FIG. 1 is a schematic diagram according to a first embodiment of the present disclosure.

FIG. 2 is a schematic diagram of a sample image in an embodiment of the present disclosure.

FIG. 3 is a schematic diagram according to a second embodiment of the present disclosure.

FIG. 4 is a schematic diagram according to a third embodiment of the present disclosure.

FIG. 5 is a schematic diagram according to a fourth embodiment of the present disclosure.

FIG. 6 is a schematic diagram according to a fifth embodiment of the present disclosure.

FIG. 7 is a schematic diagram according to a sixth embodiment of the present disclosure.

FIG. 8 is a schematic diagram according to a seventh embodiment of the present disclosure.

FIG. 9 is a block diagram of an electronic device used to implement the training method for a human body attribute detection model of an embodiment of the present disclosure.

### DETAILED DESCRIPTION

Exemplary embodiments of the present disclosure will be described below in conjunction with the accompanying drawings, which include various details of the embodiments of the present disclosure to facilitate understanding, and they should be regarded as exemplary only. Accordingly, those of ordinary skill in the art will recognize that various changes and modifications of the embodiments described herein can be made without departing from the scope and spirit of the present disclosure. Also, descriptions of well-known functions and constructions are omitted in the following description for clarity and conciseness.

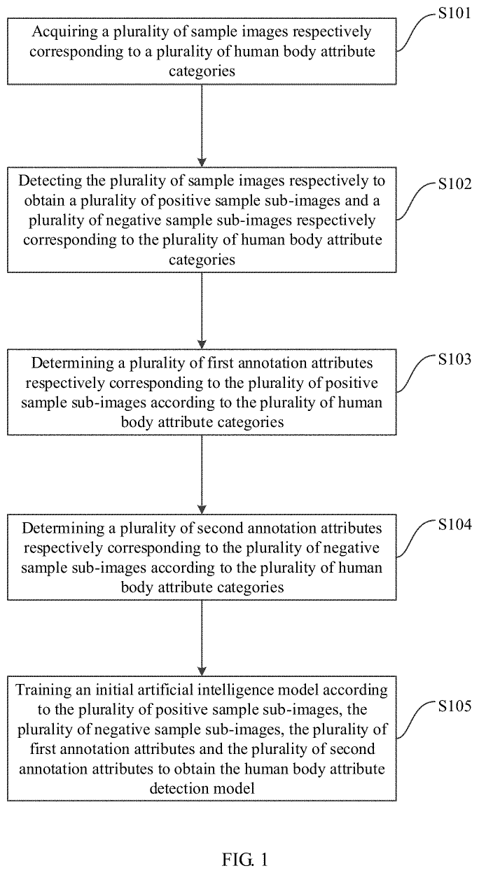

FIG. 1 is a schematic diagram according to a first embodiment of the present disclosure.

Wherein it should be noted that the execution subject of the training method for a human body attribute detection model in the present embodiment is the training apparatus for a human body attribute detection model, which can be realized in a way of software and/or hardware, and which can be configured in an electronic device, and the electronic device may include but not limited to a terminal, a server end, and the like.

The embodiments of the present disclosure relate to the technical field of artificial intelligence, specifically to the technical fields of computer vision, deep learning, and the like, and can be applied to intelligent cloud and security inspection scenarios, to improve accuracy and detection and recognition efficiency of human body attribute detection and recognition in security inspection scenarios.

Wherein Artificial Intelligence, the English abbreviation of which is AI, is a new technical science that studies and develops theories, methods, technologies and application systems for simulating, extending and expanding human intelligence.

Deep learning is to learn internal laws and representation levels of sample data. Information obtained in these learning processes is of great help to interpretation of data such as text, images, sounds, and the like. The ultimate goal of deep learning is to enable machines to have ability to analyze and learn like humans, and to be able to recognize data such as text, images, sounds, and the like.

Computer vision refers to machine vision that uses cameras and computers instead of human eyes to recognize, track and measure targets, and further performs graphics processing, so as to be processed by computers as images that are more suitable for human eyes to observe or being sent to instruments for detection.

And in security inspection scenarios, such as in the safe operation and production environment of a factory area, it is necessary to carry out inspection scenarios such as safety helmet wearing inspection, smoking inspection and phone calling inspection on staff. It should be noted that, usually in this scenario, the human body attribute detection performed on the staff is to ensure normal and safe operation.

As shown in FIG. 1, the training method for a human body attribute detection model includes:

S101: acquiring a plurality of sample images respectively corresponding to a plurality of human body attribute categories.

Wherein the categories used to describe the classification of human body attributes can be referred to as human body attribute categories. In embodiments of the present disclosure, in order to meet the needs of security inspection scenarios, a plurality of human body attribute categories can be determined, such as smoking categories, clothing categories, wearing helmet categories, phone calling categories, and the like, which will not be limited thereto.

After the above described determining the plurality of human body attribute categories, a plurality of sample images respectively corresponding to the plurality of human body attribute categories can be acquired from a sample image pool, and the sample images can be used to train the artificial intelligence model to obtain the human body attribute detection model.

That is to say, a plurality of candidate sample images respectively corresponding to the plurality of candidate human body attribute categories may be pre-stored in the sample image pool, so that a plurality of candidate human body attribute categories that match may be selected therefrom based on the determined plurality of human body attribute categories, and the candidate sample images corresponding to the candidate human body attribute categories may be used as the above described determined sample images, and there is no limitation on this.

The plurality of sample images, for example, one or more sample images corresponding to the smoking category, one or more sample images corresponding to the clothing category, one or more sample images corresponding to the wearing helmet category, one or more sample images corresponding to the phone calling category, one or more sample images corresponding to one human body attribute category, may be one or more, which will not be limited by the embodiment of the present disclosure.

S102: detecting the plurality of sample images respectively to obtain a plurality of positive sample sub-images and a plurality of negative sample sub-images respectively corresponding to the plurality of human body attribute categories.

In the above described acquiring the plurality of sample images respectively corresponding to a plurality of human body attribute categories, some image processing algorithms may be used to process the sample images in combination with corresponding human body attribute categories to obtain positive sample sub-images and negative sample sub-images of corresponding human body attribute categories.

Wherein the positive sample sub-images and the negative sample sub-images may be segmented specifically in combination with the functions of the human body attribute detection model, for example, the positive sample sub-image may be a sub-image carrying a non-smoking feature, and the negative sample sub-image may be a sub-image carrying a smoking feature, which will not be limited thereto.

In the embodiment of the present disclosure, the Hungarian algorithm may be used to detect the plurality of sample images respectively, so as to obtain a plurality of positive sample detection frames and a plurality of negative sample detection frames respectively corresponding to the plurality of sample images, and images covered by the plurality of positive sample detection frames may be respectively used as the plurality of positive sample sub-images, and images covered by the plurality of negative sample detection frames may be respectively used as the plurality of negative sample sub-images, so that it is realized that it is before the training the human body attribute detection model, that is, the function will be realized, to timely judge the positive and negative samples demarcated by the detection frames, so that the largest match between the predicted value and the true value is achieved, and it is a one-to-one correspondence, and the plurality of predicted detection frames will not be matched to the same real detection frame, so that the human body attribute detection model can deal with the problem of repeated detection in a timely manner, avoiding post-processing of non-maximum value suppression, thereby improving the efficiency of human body attribute detection.

Wherein the Hungarian algorithm is based on the idea of proof of sufficiency in Hall's theorem (Hall's theorem is the basis of the Hungarian algorithm in the bipartite graph matching problem). It is the most common algorithm for partial graph matching. The core of the algorithm is to find an augmented path. It is an algorithm that uses the augmented path to find the maximum matching of a bipartite graph.

In the above described using the Hungarian algorithm to detect the plurality of sample images respectively, so as to obtain the plurality of positive sample detection frames and the plurality of negative sample detection frames respectively corresponding to the plurality of sample images, for example, the positive sample detection frame may contain human body parts carrying non-smoking features, for example, the mouth of a human body, which indicates that the human body does not smoke, and for example, the negative sample detection frame may contain human body parts carrying smoking features, for example, the mouth of a human body, which indicates that the human body smokes. Of course, the positive sample detection frame and the negative sample detection frame may also be segmented based on other human body attribute categories, which will not be limited thereto.

In the above described obtaining the plurality of positive sample detection frames and the plurality of negative sample detection frames respectively corresponding to the plurality of sample images, the images covered by the plurality of positive sample detection frames may respectively be used as the plurality of positive sample sub-images directly, and the images covered by the plurality of negative sample detection frames may respectively used as the plurality of negative sample sub-images directly. That is, the above described human body parts carrying non-smoking features may be mapped to the partial image of the positive sample detection frame as the positive sample sub-image, and the above described human body parts carrying smoking features may be mapped to the partial image of the negative sample detection frame as the negative sample sub-image, which will not be limited thereto.

In some other embodiments, the above described using the Hungarian algorithm to detect the plurality of sample images respectively, so as to obtain the plurality of positive sample detection frames and the plurality of negative sample detection frames respectively corresponding to the plurality of sample images, may also be based on the image recognition method, to determine the image features of the partial image framed by the positive sample detection frame (carrying the non-smoking feature), and to determine the image features of the partial image framed by the negative sample detection frame (carrying the smoking feature), and then subsequent steps may be performed.

S103: determining a plurality of first annotation attributes respectively corresponding to the plurality of positive sample sub-images according to the plurality of human body attribute categories.

S104: determining a plurality of second annotation attributes respectively corresponding to the plurality of negative sample sub-images according to the plurality of human body attribute categories.

That is to say, after detecting the plurality of sample images respectively to obtain a plurality of positive sample sub-images and a plurality of negative sample sub-images respectively corresponding to the plurality of human body attribute categories, in combination with the above described plurality of human body attribute categories, a plurality of first annotation attributes respectively corresponding to the plurality of positive sample sub-images may be determined, and a plurality of second annotation attributes respectively corresponding to the plurality of negative sample sub-images may be determined.

Wherein the annotation attribute corresponding to the positive sample sub-image may be referred to as the first annotation attribute, and the annotation attribute corresponding to the negative sample sub-image may be referred to as the second annotation attribute, and the annotation attributes can be used as reference annotations when training the human body attribute detection model.

The illustrations for the steps S103 and S104 may be as follows in combination:

The determining the plurality of first annotation attributes respectively corresponding to the plurality of positive sample sub-images according to the plurality of human body attribute categories may for example be,

Assuming that the image feature corresponding to the positive sample sub-image is carrying a non-smoking feature, then it indicates that the positive sample sub-image is obtained by segmentation based on the sample image of the smoking category, so that the first annotation attribute of the positive sample sub-image can be determined as the non-smoking category attribute;

Assuming that the image feature corresponding to the positive sample sub-image is carrying a wearing helmet feature, then it indicates that the positive sample sub-image is obtained by segmentation based on the sample image of the wearing helmet category, so that the first annotation attribute of the positive sample sub-image can be determined as the wearing helmet attribute;

Assuming that the image feature corresponding to the positive sample sub-image is carrying a non-phone calling feature, then it indicates that the positive sample sub-image is obtained by segmentation based on the sample image of the phone calling category, so that the first annotation attribute of the positive sample sub-image can be determined as the non-phone calling category attribute.

Accordingly, the determining the plurality of second annotation attributes respectively corresponding to the plurality of negative sample sub-images according to the plurality of human body attribute categories may for example be,

Assuming that the image feature corresponding to the negative sample sub-image is carrying a smoking feature, then it indicates that the negative sample sub-image is obtained by segmentation based on the sample image of the smoking category, so that the second annotation attribute of the negative sample sub-image can be determined as the smoking category attribute;

Assuming that the image feature corresponding to the negative sample sub-image is carrying a non-wearing helmet feature, then it indicates that the negative sample sub-image is obtained by segmentation based on the sample image of the wearing helmet category, so that the second annotation attribute of the negative sample sub-image can be determined as the non-wearing helmet attribute;

Assuming that the image feature corresponding to the negative sample sub-image is carrying a phone calling feature, then it indicates that the negative sample sub-image is obtained by segmentation based on the sample image of the phone calling category, so that the second annotation attribute of the negative sample sub-image can be determined as the phone calling category attribute.

That is to say, the above described annotation segmentation of the first annotation attribute and the second annotation attribute may be set with reference to the pre-configured plurality of human body attribute categories and security rules in the factory area safety inspection application, which will not be limited thereto.

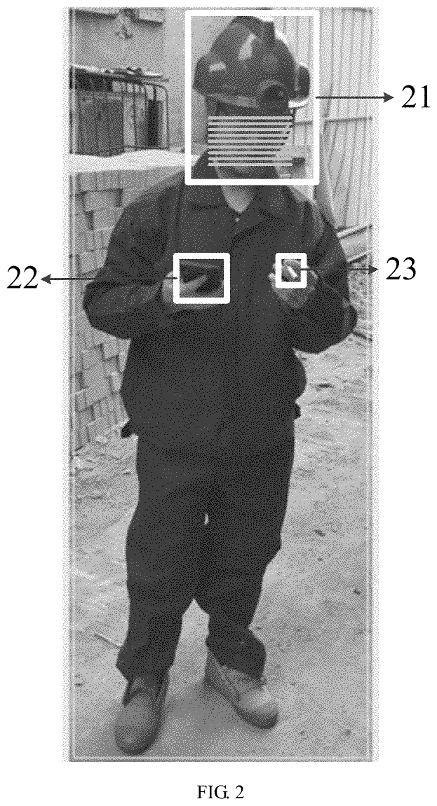

As shown in FIG. 2, FIG. 2 is a schematic diagram of a sample image in an embodiment of the present disclosure, which contains a plurality of sample detection frames, and the image features of the partial images framed by different sample detection frames may be the same or different, in which the image feature of the partial image framed by the sample detection frame 21 may, for example, carry the wearing helmet feature, the image feature of the partial image framed by the sample detection frame 22 may, for example, carry the phone calling feature, the image feature of the partial image framed by the sample detection frame 23 may, for example, carry the smoking feature, and then based on the image features carried by the partial image, the sample detection frame 21, the sample detection frame 22, and the sample detection frame 23 can be segmented into positive sample sub-images and negative sample sub-images, and the first annotation attributes corresponding to the positive sample sub-images and the second annotation attributes corresponding to the negative sample sub-images can be determined.

S105: training an initial artificial intelligence model according to the plurality of positive sample sub-images, the plurality of negative sample sub-images, the plurality of first annotation attributes and the plurality of second annotation attributes to obtain the human body attribute detection model.

After the above described determining the plurality of first annotation attributes respectively corresponding to the plurality of positive sample sub-images and determining the plurality of second annotation attributes respectively corresponding to the plurality of negative sample sub-images according to the plurality of human body attribute categories, the initial artificial intelligence model may be trained according to the plurality of positive sample sub-images, the plurality of negative sample sub-images, the plurality of first annotation attributes and the plurality of second annotation attributes to obtain the human body attribute detection model.

Wherein the initial artificial intelligence model may be, for example, a neural network model, a machine learning model, or may also be a graph neural network model. Of course, any other possible models capable of performing image processing tasks may also be used, which are not limited.

That is to say, a plurality of positive sample sub-images, a plurality of negative sample sub-images, a plurality of first annotation attributes and a plurality of second annotation attributes may be inputted to the initial artificial intelligence model, and the convergence timing of the initial artificial intelligence model may be determined by using any possible way, and until the artificial intelligence model meets a certain convergence condition, the artificial intelligence model obtained by training is used as the human body attribute detection model.

In the present embodiment, by acquiring a plurality of sample images respectively corresponding to a plurality of human body attribute categories, and detecting the plurality of sample images respectively to obtain a plurality of positive sample sub-images and a plurality of negative sample sub-images respectively corresponding to the plurality of human body attribute categories, determining a plurality of first annotation attributes respectively corresponding to the plurality of positive sample sub-images according to the plurality of human body attribute categories, determining a plurality of second annotation attributes respectively corresponding to the plurality of negative sample sub-images according to the plurality of human body attribute categories, and training an initial artificial intelligence model according to the plurality of positive sample sub-images, the plurality of negative sample sub-images, the plurality of first annotation attributes and the plurality of second annotation attributes to obtain the human body attribute detection model, since a fine-grained annotation attribute segmentation is performed on a plurality of sample images based on human body attribute categories, the feature dimension of the annotation data for training is expanded, so that the human body attribute detection model obtained by training can effectively model fine-grained attributes of the human body, improve feature expression ability of the human body attribute detection model for human body images, and effectively improve accuracy and detection efficiency of human body attribute detection.

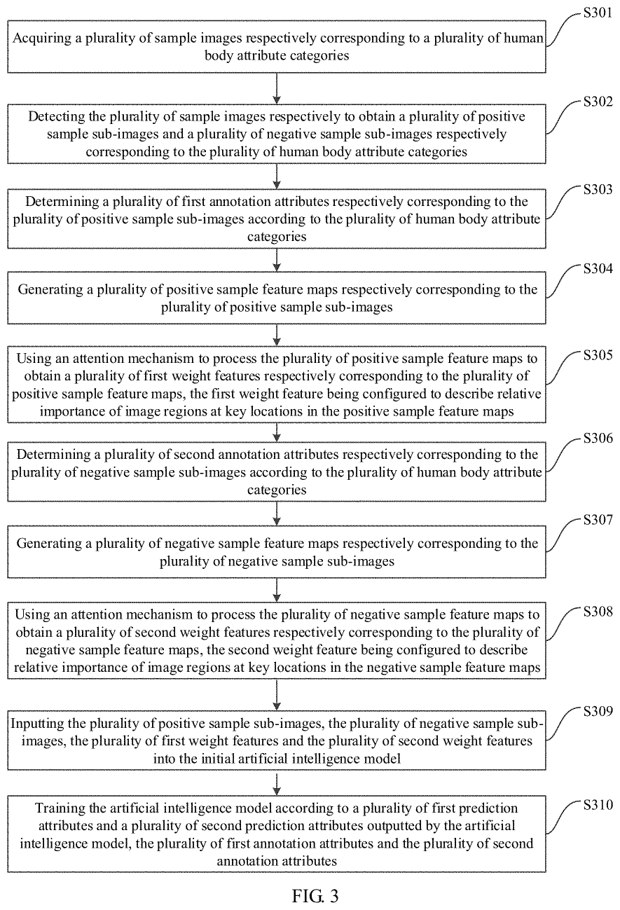

FIG. 3 is a schematic diagram according to a second embodiment of the present disclosure.

As shown in FIG. 3, the training method for a human body attribute detection model includes:

S301: acquiring a plurality of sample images respectively corresponding to a plurality of human body attribute categories.

S302: detecting the plurality of sample images respectively to obtain a plurality of positive sample sub-images and a plurality of negative sample sub-images respectively corresponding to the plurality of human body attribute categories.

S303: determining a plurality of first annotation attributes respectively corresponding to the plurality of positive sample sub-images according to the plurality of human body attribute categories;

For the illustration of S301-S303, reference may be made to the foregoing embodiment, and the details will not be repeated here.

S304: generating a plurality of positive sample feature maps respectively corresponding to the plurality of positive sample sub-images.

Wherein the image features mainly include color features, texture features, shape features, and spatial relationship features, and the like, of the image, and then the feature map may be used to describe these image features, and the feature map may specifically be presented based on the time domain dimension, or may be presented based on the frequency domain dimension, which will not be limited here.

The aforementioned feature map corresponding to the positive sample sub-image may be referred to as the positive sample feature map.

In the present embodiment, the generated plurality of positive sample feature maps respectively corresponding to the plurality of positive sample sub-images may be used to determine relative importance of image regions at key positions in the positive sample feature maps, and the relative importance can be used for subsequent training of artificial intelligence models.

S305: using an attention mechanism to process the plurality of positive sample feature maps to obtain a plurality of first weight features respectively corresponding to the plurality of positive sample feature maps, the first weight feature being configured to describe relative importance of image regions at key locations in the positive sample feature maps.

The above described key position in the positive sample feature map may be, for example, the position corresponding to the feature of the useful region in the positive sample feature map. Assuming that the positive sample feature map correspondingly carries the wearing helmet feature, then correspondingly, since the helmet is worn on the head, the position in the positive sample feature map, to which the head corresponds, can be referred to as a key position, and the importance of the region corresponding to the key position relative to other image positions can be referred to as relative importance, and the relative importance may be annotated with a certain numerical value, which will not be limited here.

In the present embodiment, when training the artificial intelligence model, the artificial intelligence model may be a deformable detector for end-to-end object detection (Deformable Transformers for End-to-End Object Detection, Deformable DETR), so that in the embodiment of the present disclosure, by generating a plurality of positive sample feature maps respectively corresponding to a plurality of positive sample sub-images, the sample data for training can be enabled to be better adapted to the model, which reduces the amount of data processing of the model, and by using the attention mechanism to process the plurality of positive sample feature maps, and learning and recognizing the relative importance of the image regions at the key positions in the positive sample feature maps, and using the positive sample sub-images and the corresponding plurality of first weight features as input of the model, the feature expression ability of the artificial intelligence model for positive sample sub-images can be effectively improved, and while ensuring the effect of model training, the efficiency of model training can be effectively improved.

The above-mentioned attention mechanism may specifically be, for example, the self-attention mechanism or the channel attention mechanism in the related art, which is not limited here.

That is to say, before training the artificial intelligence model, the attention mechanism can be used to process a plurality of positive sample feature maps to obtain a plurality of first weight features respectively corresponding to a plurality of positive sample feature maps, and the first weight features can be used to assist the training of the artificial intelligence model, which can effectively improve the sensitivity of the human body attribute detection model obtained by training to useful information in the image, thereby being able to help to improve the detection and recognition effect of the human body attribute detection model.

S306: determining a plurality of second annotation attributes respectively corresponding to the plurality of negative sample sub-images according to the plurality of human body attribute categories.

For the illustration of S306, reference may be made to the foregoing embodiment, and the details will not be described here again.

S307: generating a plurality of negative sample feature maps respectively corresponding to the plurality of negative sample sub-images.

The aforementioned feature map corresponding to the negative sample sub-image may be referred to as the negative sample feature map.

In the present embodiment, the generated plurality of negative sample feature maps respectively corresponding to the plurality of negative sample sub-images may be used to determine relative importance of image regions at key positions in the negative sample feature maps, and the relative importance can be used for subsequent training of artificial intelligence models.

S308: using an attention mechanism to process the plurality of negative sample feature maps to obtain a plurality of second weight features respectively corresponding to the plurality of negative sample feature maps, the second weight feature being configured to describe relative importance of image regions at key locations in the negative sample feature maps.

The above described key position in the negative sample feature map may be, for example, the position corresponding to the feature of the useful region in the negative sample feature map. Assuming that the negative sample feature map correspondingly carries the non-wearing helmet feature, then correspondingly, since the helmet is worn on the head, the position in the negative sample feature map, to which the head corresponds, can be referred to as a key position, and the importance of the region corresponding to the key position relative to other image positions can be referred to as relative importance, and the relative importance may be annotated with a certain numerical value, which will not be limited here.

In the embodiment of the present disclosure, by generating a plurality of negative sample feature maps respectively corresponding to a plurality of negative sample sub-images, the sample data for training can be enabled to be better adapted to the model, which reduces the amount of data processing of the model, and by using the attention mechanism to process the plurality of negative sample feature maps, and learning and recognizing the relative importance of the image regions at the key positions in the negative sample feature maps, and using the negative sample sub-images and the corresponding plurality of second weight features as input of the model, the feature expression ability of the artificial intelligence model for negative sample sub-images can be effectively improved, and while ensuring the effect of model training, the efficiency of model training can be effectively improved.

The above-mentioned attention mechanism may specifically be, for example, the self-attention mechanism or the channel attention mechanism in the related art, which is not limited here.

That is to say, before training the artificial intelligence model, the attention mechanism can be used to process a plurality of negative sample feature maps to obtain a plurality of second weight features respectively corresponding to a plurality of negative sample feature maps, and the second weight features can be used to assist the training of the artificial intelligence model, which can effectively improve the sensitivity of the human body attribute detection model obtained by training to useful information in the image, thereby being able to help to improve the detection and recognition effect of the human body attribute detection model.

S309: inputting the plurality of positive sample sub-images, the plurality of negative sample sub-images, the plurality of first weight features and the plurality of second weight features into the initial artificial intelligence model.

After the above described obtaining the plurality of positive sample sub-images, the plurality of negative sample sub-images, the plurality of first weight features and the plurality of second weight features, the aforementioned contents can be used to train the initial artificial intelligence model.

The initial artificial intelligence model may be, for example, the deformable detector for end-to-end object detection, Deformable DETR model, that is, the Deformable DETR model using the plurality of positive sample sub-images, the plurality of negative sample sub-images, the plurality of first weight features and the plurality of second weight features, since the plurality of positive sample sub-images and the plurality of negative sample sub-images are obtained by annotation segmentation based on the human body attribute categories, and the first weight features can be used to describe the relative importance of the image regions at the key positions in the positive sample feature maps, and the second weight features are used to describe the relative importance of the image regions at the key positions in the negative sample feature maps.

Therefore, in the embodiment of the present disclosure, the sensitivity of the human body attribute detection model obtained by training to useful information in the image can be effectively improved, thereby being able to help to improve the detection and recognition effect of the human body attribute detection model, and effectively improve the robustness of the human body attribute detection model.

S310: training the artificial intelligence model according to a plurality of first prediction attributes and a plurality of second prediction attributes outputted by the artificial intelligence model, the plurality of first annotation attributes and the plurality of second annotation attributes.

Wherein the first prediction attribute is obtained by prediction by the artificial intelligence model according to the positive sample sub-image and the corresponding first weight feature, and the second prediction attribute is obtained by prediction by the artificial intelligence model according to the negative sample sub-image and the corresponding second weight feature.

Wherein the prediction attribute, which is obtained by prediction by the artificial intelligence model according to the positive sample sub-image and the corresponding first weight feature, may be referred to as the first prediction attribute, and the prediction attribute, which is obtained by prediction by the artificial intelligence model according to the negative sample sub-image and the corresponding second weight feature, may be referred to as the second prediction attribute, and in the training process, the human body attributes outputted by the artificial intelligence model can be referred to as prediction attributes.

For example, assuming that the input for the Deformable DETR model is the above described positive sample sub-images and negative sample sub-images contained in the respective detection frames in FIG. 2, and the above described first weight features and second weight features calculated based on the attention mechanism are also inputted to the Deformable DETR model, then the Deformable DETR model can perform corresponding model operations based on the input, and output an unordered set including all targets (the prediction attributes respectively corresponding to the positive sample sub-images and the negative sample sub-images), and then the timing of model convergence can be determined based on the first prediction attributes and the second prediction attributes.

In the present embodiment, by acquiring a plurality of sample images respectively corresponding to a plurality of human body attribute categories, and detecting the plurality of sample images respectively to obtain a plurality of positive sample sub-images and a plurality of negative sample sub-images respectively corresponding to the plurality of human body attribute categories, determining a plurality of first annotation attributes respectively corresponding to the plurality of positive sample sub-images according to the plurality of human body attribute categories, determining a plurality of second annotation attributes respectively corresponding to the plurality of negative sample sub-images according to the plurality of human body attribute categories, and training an initial artificial intelligence model according to the plurality of positive sample sub-images, the plurality of negative sample sub-images, the plurality of first annotation attributes and the plurality of second annotation attributes to obtain the human body attribute detection model, since a fine-grained annotation attribute segmentation is performed on a plurality of sample images based on human body attribute categories, the feature dimension of the annotation data for training is expanded, so that the human body attribute detection model obtained by training can effectively model fine-grained attributes of the human body, improve feature expression ability of the human body attribute detection model for human body images, and effectively improve accuracy and detection efficiency of human body attribute detection. And since the human body attribute detection model obtained by training is obtained by training based on the partial images and the annotation attributes in the sample images, the output result of the human body attribute detection model can present the partial region of the target in the real-time image or the video frame, and the human body attributes recognized for the partial region, so that in the embodiment of the present disclosure, by matching the detected worker as a whole with the partial image region of the human body attribute, the phenomenon of missed detection and false detection in respective separate detection is effectively avoided, and detection accuracy and detection robustness are improved.

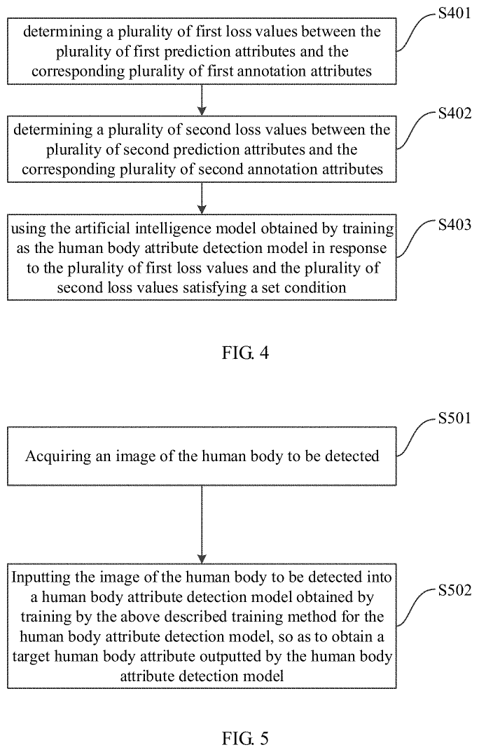

FIG. 4 is a schematic diagram according to a third embodiment of the present disclosure.

As shown in FIG. 4, the training method for a human body attribute detection model includes:

S401: determining a plurality of first loss values between the plurality of first prediction attributes and the corresponding plurality of first annotation attributes.

In the training the artificial intelligence model according to the plurality of first prediction attributes and the plurality of second prediction attributes outputted by the artificial intelligence model, the plurality of first annotation attributes and the plurality of second annotation attributes, the differences between the plurality of first prediction attributes and the corresponding plurality of first annotation attributes may be dynamically determined, and a certain calculation method is used to perform quantization processing on the differences, and the value processed by quantization are used as the first loss values.

S402: determining a plurality of second loss values between the plurality of second prediction attributes and the corresponding plurality of second annotation attributes.

In the training the artificial intelligence model according to the plurality of first prediction attributes and the plurality of second prediction attributes outputted by the artificial intelligence model, the plurality of first annotation attributes and the plurality of second annotation attributes, the differences between the plurality of second prediction attributes and the corresponding plurality of second annotation attributes may be dynamically determined, and a certain calculation method is used to perform quantization processing on the differences, and the value processed by quantization are used as the second loss values.

In some other embodiments, the loss functions may also be configured for the Deformable DETR model, and the loss functions may be used to fit the above differences, and the loss functions may specifically calculate loss values of three aspects, and weight the loss values of the three aspects, for example, the loss value, between the prediction frame and the real frame of the key region in the sample sub-image, of the artificial intelligence model, the loss value between the prediction attribute and the annotation attribute, and the intersection-union ratio loss value between the prediction frame and the real frame, which will not be limited here.

In applications, loss functions are usually associated with optimization problems as learning criteria, i.e., models will be solved and evaluated by minimizing the loss functions.

S403: using the artificial intelligence model obtained by training as the human body attribute detection model in response to the plurality of first loss values and the plurality of second loss values satisfying a set condition.

In the above described determination of the convergence timing of the Deformable DETR model, it may be that a plurality of first loss values and a plurality of second loss values meet the set condition, and if the plurality of first loss values and the corresponding plurality of second loss values meet the set condition, the Deformable DETR model obtained by training is used as the human body attribute detection model.

After the above described determination of a plurality of first loss values and a plurality of second loss values, it can be determined in real time whether the plurality of first loss values and the plurality of second loss values meet the set condition (for example, if a set number of loss values among the plurality of first loss values and the plurality of second loss values are less than a loss threshold, it is judged that the plurality of first loss values and the plurality of second loss values meet the set condition, the loss threshold may be a threshold value of the loss value, which is pre-demarcated and is used to determine the convergence of the initial Deformable DETR model), and if a set number of loss values among the plurality of first loss values and the plurality of second loss values are less than the loss threshold, the Deformable DETR model obtained by training is used as the human body attribute detection model, that is, the training of the Deformable DETR model is completed, and the human body attribute detection model at this time meets the preset convergence condition.

After the above described obtaining the human body attribute detection model by training, the human body attribute detection model can be used to recognize and detect human body attributes in intelligent cloud and security inspection scenarios. For example, by using the trained human body attribute detection model, the real-time image or video frame of the safe production factory can be used as input to obtain the output of the human body attribute detection model, and the output includes: worker location, head wearing helmet and head not wearing helmet, presence or absence of smoking, phone calling.

And then, the detection results of the head not wearing helmet, smoking, and phone calling can be matched with the locations of pedestrians to further eliminate false detections, and the matched target is judged as a scenario with potential hazard; for a target, which is detected by the human body attribute detection model as potentially having potential hazard, the system automatically annotates it with a specific color on the screen, and then it can also support counting the corresponding number of people. At the same time, the corresponding detection results and statistical information can also be sent by the electronic device to the smart device of the inspector, to carry out alarm reminders, so as to ensure the inspection efficiency of the security inspection scenarios in one stop, and greatly reduce the safety hazards of the safety production factory.

In the present embodiment, in the training of the artificial intelligence model according to the plurality of first prediction attributes and the plurality of second prediction attributes outputted by the artificial intelligence model, the plurality of first annotation attributes and the plurality of second annotation attributes, a plurality of first loss values between the plurality of first prediction attributes and the corresponding plurality of first annotation attributes may be determined, a plurality of second loss values between the plurality of second prediction attributes and the corresponding plurality of second annotation attributes may be determined, and the artificial intelligence model obtained by training may be used as the human body attribute detection model if the plurality of first loss values and the plurality of second loss values meet a set condition, so that the human body attribute detection model obtained by training can effectively model the image features of human body attributes in intelligent cloud and security inspection scenarios, the representational capacity for human body attributes in intelligent cloud and security inspection scenarios, of the human body attribute detection model, can be improved, and the effect of detection and recognition of the human body attributes by the human body attribute detection model can be effectively improved.

FIG. 5 is a schematic diagram according to a fourth embodiment of the present disclosure.

As shown in FIG. 5, the human body attribute recognition method includes:

S501: acquiring an image of the human body to be detected.

Wherein the image of the human body to be recognized and detected at present may be referred to as the image of the human body to be detected.

The image of the human body to be detected may be obtained by capturing by a camera device in intelligent cloud and security inspection scenario, and there is no limitation on this.

S502: inputting the image of the human body to be detected into a human body attribute detection model obtained by training by the above described training method for the human body attribute detection model, so as to obtain a target human body attribute outputted by the human body attribute detection model.

After the above described acquisition of the image of the human body to be detected, the image of the human body to be detected may be inputted in real time into a human body attribute detection model obtained by training by the training method for the human body attribute detection model as described above, so as to obtain a target human body attribute outputted by the human body attribute detection model.

The target human body attribute may be, for example, a smoking attribute, a non-smoking attribute, a phone calling attribute, or a non-phone calling attribute, etc., which will not be limited here.

In the present embodiment, by acquiring an image of the human body to be detected, and inputting the image of the human body to be detected into a human body attribute detection model obtained by training by the training method for the human body attribute detection model as described above, so as to obtain a target human body attribute outputted by the human body attribute detection model, because the human body attribute detection model obtained by training can effectively model the image features of human body attributes in intelligent cloud and security inspection scenarios, the effect of recognition of the human body attributes can be effectively improved.

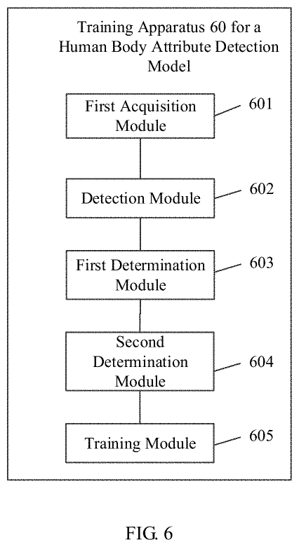

FIG. 6 is a schematic diagram according to a fourth embodiment of the present disclosure.

As shown in FIG. 6, the training apparatus 60 for a human body attribute detection model includes:

a first acquisition module 601 configured to acquire a plurality of sample images respectively corresponding to a plurality of human body attribute categories;

a detection module 602 configured to detect the plurality of sample images respectively to obtain a plurality of positive sample sub-images and a plurality of negative sample sub-images respectively corresponding to the plurality of human body attribute categories;

a first determination module 603 configured to determine a plurality of first annotation attributes respectively corresponding to the plurality of positive sample sub-images according to the plurality of human body attribute categories;

a second determination module 604 configured to determine a plurality of second annotation attributes respectively corresponding to the plurality of negative sample sub-images according to the plurality of human body attribute categories; and

a training module 605 configured to train an initial artificial intelligence model according to the plurality of positive sample sub-images, the plurality of negative sample sub-images, the plurality of first annotation attributes and the plurality of second annotation attributes to obtain the human body attribute detection model.

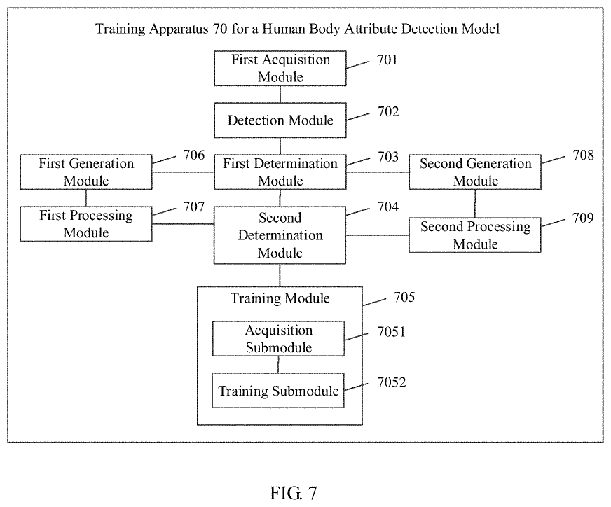

In some embodiments of the present disclosure, as shown in FIG. 7, which is a schematic diagram according to the fifth embodiment of the present disclosure, the training apparatus 70 for a human body attribute detection model includes: a first acquisition module 701, a detection module 702, the first determination module 703, the second determination module 704, the training module 705, and the apparatus 70 further includes:

a first generation module 706 configured to generate a plurality of positive sample feature maps respectively corresponding to the plurality of positive sample sub-images;

a first processing module 707 configured to use an attention mechanism to process the plurality of positive sample feature maps to obtain a plurality of first weight features respectively corresponding to the plurality of positive sample feature maps, the first weight feature being configured to describe relative importance of image regions at key locations in the positive sample feature maps.

In some embodiments of the present disclosure, as shown in FIG. 7, the apparatus further includes:

a second generation module 708 configured to generate a plurality of negative sample feature maps respectively corresponding to the plurality of negative sample sub-images;

a second processing module 709 configured to use an attention mechanism to process the plurality of negative sample feature maps to obtain a plurality of second weight features respectively corresponding to the plurality of negative sample feature maps, the second weight feature being configured to describe relative importance of image regions at key locations in the negative sample feature maps.

In some embodiments of the present disclosure, as shown in FIG. 7, wherein the training module 705 includes:

an acquisition submodule 7051 configured to input the plurality of positive sample sub-images, the plurality of negative sample sub-images, the plurality of first weight features and the plurality of second weight features into the initial artificial intelligence model;

a training submodule 7052 configured to train the artificial intelligence model according to a plurality of first prediction attributes and a plurality of second prediction attributes outputted by the artificial intelligence model, the plurality of first annotation attributes and the plurality of second annotation attributes;

wherein the first prediction attribute is obtained by prediction by the artificial intelligence model according to the positive sample sub-image and the corresponding first weight feature, and the second prediction attribute is obtained by prediction by the artificial intelligence model according to the negative sample sub-image and the corresponding second weight feature.

In some embodiments of the present disclosure, wherein the training submodule 7052 is specifically configured to:

determine a plurality of first loss values between the plurality of first prediction attributes and the corresponding plurality of first annotation attributes;

determine a plurality of second loss values between the plurality of second prediction attributes and the corresponding plurality of second annotation attributes;

use the artificial intelligence model obtained by training as the human body attribute detection model in response to the plurality of first loss values and the plurality of second loss values satisfying a set condition.

In some embodiments of the present disclosure, wherein the detection module 702 is specifically configured to:

use the Hungarian algorithm to detect the plurality of sample images respectively, so as to obtain a plurality of positive sample detection frames and a plurality of negative sample detection frames respectively corresponding to the plurality of sample images;

use images covered by the plurality of positive sample detection frames respectively as the plurality of positive sample sub-images, and use images covered by the plurality of negative sample detection frames respectively as the plurality of negative sample sub-images.

It can be understood that the training apparatus 70 for a human body attribute detection model in FIG. 7 of the present embodiment and the training apparatus 60 for a human body attribute detection model in the above described embodiment, the first acquisition module 701 and the first acquisition module 601 in the above described embodiment, the detection module 702 and the detection module 602 in the above described embodiment, the first determination module 703 and the first determination module 603 in the above described embodiment, the second determination module 704 and the second determination module 604 in the above described embodiment, the training module 705 and the training module 605 in the above described embodiment, may have the same function and structure.

It should be noted that the foregoing explanations of the training method for the human body attribute detection model are also applicable to the training device for the training apparatus for the human body attribute detection model of the present embodiment, and will not be repeated here.

In the present embodiment, by acquiring a plurality of sample images respectively corresponding to a plurality of human body attribute categories, and detecting the plurality of sample images respectively to obtain a plurality of positive sample sub-images and a plurality of negative sample sub-images respectively corresponding to the plurality of human body attribute categories, determining a plurality of first annotation attributes respectively corresponding to the plurality of positive sample sub-images according to the plurality of human body attribute categories, determining a plurality of second annotation attributes respectively corresponding to the plurality of negative sample sub-images according to the plurality of human body attribute categories, and training an initial artificial intelligence model according to the plurality of positive sample sub-images, the plurality of negative sample sub-images, the plurality of first annotation attributes and the plurality of second annotation attributes to obtain the human body attribute detection model, since a fine-grained annotation attribute segmentation is performed on a plurality of sample images based on human body attribute categories, the feature dimension of the annotation data for training is expanded, so that the human body attribute detection model obtained by training can effectively model fine-grained attributes of the human body, improve feature expression ability of the human body attribute detection model for human body images, and effectively improve accuracy and detection efficiency of human body attribute detection.

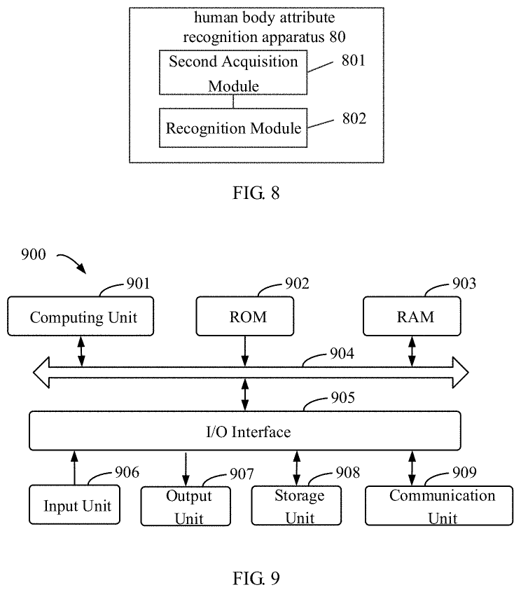

FIG. 8 is a schematic diagram according to a seventh embodiment of the present disclosure.

As shown in FIG. 8, the human body attribute recognition apparatus 80 includes:

a second acquisition module 801 configured to acquire an image of the human body to be detected;

a recognition module 802 configured to input the image of the human body to be detected into a human body attribute detection model obtained by training by the training apparatus for the human body attribute detection model according to any one of the above claims 8-13, so as to obtain a target human body attribute outputted by the human body attribute detection model.

It should be noted that the foregoing explanations on the human body attribute recognition method are also applicable to the human body attribute recognition apparatus of the present embodiment, and will not be repeated here.

In the present embodiment, by acquiring an image of the human body to be detected, and inputting the image of the human body to be detected into a human body attribute detection model obtained by training by the training method for the human body attribute detection model as described above, so as to obtain a target human body attribute outputted by the human body attribute detection model, because the human body attribute detection model obtained by training can effectively model the image features of human body attributes in intelligent cloud and security inspection scenarios, the effect of recognition of the human body attributes can be effectively improved.

According to the embodiments of the present disclosure, the present disclosure also provides an electronic device, a readable storage medium, and a computer program product.

FIG. 9 is a block diagram of an electronic device that is used to implement the training method for a human body attribute detection model of embodiments of the present disclosure. An electronic device is intended to represent various forms of digital computers, such as laptops, desktops, workstations, personal digital assistants, servers, blade servers, mainframes, and other suitable computers. An electronic device may also represent various forms of mobile apparatuses, such as personal digital processing, cellular telephones, smart phones, wearable devices, and other similar computing apparatuses. The components shown herein, their connections and relationships, and their functions, are by way of example only, and are not intended to limit implementations of the present disclosure described and/or claimed herein.

As shown in FIG. 9, a device 900 includes a computing unit 901 that can perform various appropriate actions and processes according to a computer program stored in a read-only memory (ROM) 902 or a computer program loaded from a storage unit 908 into a random access memory (RAM) 903. Various appropriate actions and processes are performed. In the RAM 903, various programs and data necessary for the operation of the device 900 can also be stored. The computing unit 901, the ROM 902, and the RAM 903 are connected to each other through a bus 904. An input/output (I/O) interface 905 is also connected to the bus 904.

Multiple components in the device 900 are connected to the I/O interface 905, including: an input unit 906, such as a keyboard, a mouse, etc.; an output unit 907, such as various types of displays, speakers, etc.; a storage unit 908, such as a magnetic disk, an optical disk, and the like; and a communication unit 909, such as a network card, a modem, a wireless communication transceiver, and the like. The communication unit 909 allows the device 900 to exchange information/data with other devices through a computer network such as the Internet and/or various telecommunication networks.

The computing unit 901 may be various general-purpose and/or special-purpose processing components having processing and computing capabilities. Some examples of the computing unit 901 include, but are not limited to, central processing units (CPUs), graphics processing units (GPUs), various dedicated artificial intelligence (AI) computing chips, various computing units that run machine learning model algorithms, digital signal processing processor (DSP), and any suitable processors, controllers, microcontrollers, and the like. The computing unit 901 executes various methods and processes described above, such as the training method for a human body attribute detection model or the human body attribute recognition method.

For example, in some embodiments, the training method for a human body attribute detection model or the human body attribute recognition method may be implemented as computer software programs, which are tangibly included in a machine-readable medium, such as the storage unit 908. In some embodiments, part or all of the computer programs can be loaded and/or installed on the device 900 via the ROM 902 and/or the communication unit 909. When the computer program is loaded into the RAM 903 and executed by the computing unit 901, one or more steps of the training method for a human body attribute detection model or the human body attribute recognition method described above may be executed. Alternatively, in other embodiments, the computing unit 901 may be configured to execute the training method for a human body attribute detection model or the human body attribute recognition method in any other appropriate manner (for example, by means of firmware).

Various embodiments of the systems and techniques described above herein can be implemented in digital electronic circuit systems, integrated circuit systems, field programmable gate arrays (FPGAs), application specific integrated circuits (ASICs), application specific standard products (ASSPs), system of System-On-Chip (SOC), Load Programmable Logic Device (CPLD), computer hardware, firmware, software, and/or combinations thereof. These various embodiments may include: being implemented in one or more computer programs, which can be executed and/or interpreted on a programmable system including at least one programmable processor, and the programmable processor may be a special-purpose or a general-purpose programmable processor, can receive data and instructions from a storage system, at least one input device, and at least one output device, and transmit data and instructions to this storage system, this at least one input device, and this at least one output device.

Program codes for implementing the training method for a human body attribute detection model or the human body attribute recognition method of the present disclosure may be written in any combination of one or more programming languages. These program codes may be provided to a processor or a controller of a general-purpose computer, a special purpose computer, or other programmable data processing devices, so that the program codes, when executed by the processor or the controller, cause functions/operations specified in the flow diagrams and/or the block diagrams to be implemented. The program codes may be executed entirely on a machine, partly on a machine, as a stand-alone software package partly on a machine and partly on a remote machine or entirely on the remote machine or a server.

In the context of the present disclosure, the machine-readable medium may be a tangible medium that may contain or store a program for use by or in conjunction with an instruction execution system, an apparatus, or a device. The machine-readable medium may be a machine-readable signal medium or a machine-readable storage medium. The machine-readable medium may include, but is not limited to, electronic, magnetic, optical, electromagnetic, infrared, or semiconductor systems, apparatus, or devices, or any suitable combination of the foregoing. More specific examples of machine-readable storage media would include electrical connections based on one or more wires, portable computer disks, hard disks, Random Access Memories (RAMs), Read Only Memories (ROMs), Erasable Programmable Read Only Memories (EPROMs or flash memories), fiber optics, portable compact disk read-only memories (CD-ROMs), optical storage devices, magnetic storage devices, or any suitable combination of the foregoing.

To provide for interaction with a user, the systems and techniques described here can be implemented on a computer, which has: a display device (for example, a CRT (cathode ray tube) or LCD (liquid crystal display) monitor) for displaying information to the user; and a keyboard and pointing device (for example, a mouse or a trackball), through which the user can provide input to the computer. Other kinds of devices may also be used to provide interaction with the user; for example, feedback provided to the user may be any form of sensory feedback (for example, visual feedback, auditory feedback, or tactile feedback); and input from the user may be received in any form (including acoustic input, voice input, or tactile input).

The systems and techniques described here may be implemented in a computing system (for example, as a data server) that includes back-end components, or a computing system (for example, an application server) that includes middleware components, or a computing system (for example, a user computer having a graphical user interface or a web browser, through which a user can interact with embodiments of the systems and techniques described here) that includes front-end components, or a computing system that includes any combination of such back-end components, middleware components, or front-end components. The components of the system can be interconnected by any form or medium of digital data communication (for example, a communication network). Examples of the communication network include: local area networks (LANs), wide area networks (WANs), the Internet, and blockchain networks.

The computer system may include clients and servers. Clients and servers are generally remote from each other and typically interact through a communication network. The relationship of client and server will be generated by computer programs running on the respective computers and having a client-server relationship to each other. The server may be a cloud server, also known as cloud computing server or cloud host, which is a host product in the cloud computing service system to solve defects such as difficult management and weak business scalability existing in the traditional physical host and the VPS service (“Virtual Private Server”, or “VPS” for short). The server may also be a server of a distributed system, or a server combined with a blockchain.

It should be understood that steps may be reordered, added or deleted using the various forms of flow shown above. For example, the respective steps disclosed in the present disclosure may be executed in parallel, may also be executed sequentially, or may also be executed in a different order, as long as the desired result of the technical solutions disclosed in the present disclosure can be achieved, and no limitation is imposed thereto herein.

The specific embodiments described above do not constitute a limitation on the protection scope of the present disclosure. It should be apparent to those skilled in the art that various modifications, combinations, sub-combinations and substitutions may be made depending on design requirements and other factors. Any modifications, equivalent replacements and improvements made within the spirit and the principle of the present disclosure shall be included within the protection scope of the present disclosure.

What is claimed is:

1. A training method for a human body attribute detection model, comprising:
acquiring a plurality of sample images respectively corresponding to a plurality of human body attribute categories;
detecting the plurality of sample images respectively to obtain a plurality of positive sample sub-images and a plurality of negative sample sub-images respectively corresponding to the plurality of human body attribute categories;
determining a plurality of first annotation attributes respectively corresponding to the plurality of positive sample sub-images according to the plurality of human body attribute categories;
determining a plurality of second annotation attributes respectively corresponding to the plurality of negative sample sub-images according to the plurality of human body attribute categories; and
training an initial artificial intelligence model according to the plurality of positive sample sub-images, the plurality of negative sample sub-images, the plurality of first annotation attributes and the plurality of second annotation attributes to obtain the human body attribute detection model.

2. The method according to claim 1, after the determining the plurality of first annotation attributes respectively corresponding to the plurality of positive sample sub-images according to the plurality of human body attribute categories, further comprising:
generating a plurality of positive sample feature maps respectively corresponding to the plurality of positive sample sub-images;
using an attention mechanism to process the plurality of positive sample feature maps to obtain a plurality of first weight features respectively corresponding to the plurality of positive sample feature maps, the first weight feature being configured to describe relative importance of image regions at key locations in the positive sample feature maps.

3. The method according to claim 2, after the determining the plurality of second annotation attributes respectively corresponding to the plurality of negative sample sub-images according to the plurality of human body attribute categories, further comprising:
generating a plurality of negative sample feature maps respectively corresponding to the plurality of negative sample sub-images;
using an attention mechanism to process the plurality of negative sample feature maps to obtain a plurality of second weight features respectively corresponding to the plurality of negative sample feature maps, the second weight feature being configured to describe relative importance of image regions at key locations in the negative sample feature maps.

4. The method according to claim 3, wherein the training the artificial intelligence model according to the plurality of positive sample sub-images, the plurality of negative sample sub-images, the plurality of first annotation attributes and the plurality of second annotation attributes to obtain the human body attribute detection model comprises:
inputting the plurality of positive sample sub-images, the plurality of negative sample sub-images, the plurality of first weight features and the plurality of second weight features into the initial artificial intelligence model;
training the artificial intelligence model according to a plurality of first prediction attributes and a plurality of second prediction attributes outputted by the artificial intelligence model, the plurality of first annotation attributes and the plurality of second annotation attributes;
wherein the first prediction attribute is obtained by prediction by the artificial intelligence model according to the positive sample sub-image and the corresponding first weight feature, and the second prediction attribute is obtained by prediction by the artificial intelligence model according to the negative sample sub-image and the corresponding second weight feature.

5. The method according to claim 4, wherein the training the artificial intelligence model according to the plurality of first prediction attributes and the plurality of second prediction attributes outputted by the artificial intelligence model, the plurality of first annotation attributes and the plurality of second annotation attributes comprises:
determining a plurality of first loss values between the plurality of first prediction attributes and the corresponding plurality of first annotation attributes;
determining a plurality of second loss values between the plurality of second prediction attributes and the corresponding plurality of second annotation attributes;
using the artificial intelligence model obtained by training as the human body attribute detection model in response to the plurality of first loss values and the plurality of second loss values satisfying a set condition.

6. The method according to claim 1, wherein the detecting the plurality of sample images respectively to obtain the plurality of positive sample sub-images and the plurality of negative sample sub-images respectively corresponding to the plurality of human body attribute categories comprises:
using the Hungarian algorithm to detect the plurality of sample images respectively, so as to obtain a plurality of positive sample detection frames and a plurality of negative sample detection frames respectively corresponding to the plurality of sample images;
using images covered by the plurality of positive sample detection frames respectively as the plurality of positive sample sub-images, and using images covered by the plurality of negative sample detection frames respectively as the plurality of negative sample sub-images.

7. The method according to claim 1, comprising:
acquiring an image of the human body to be detected;
inputting the image of the human body to be detected into the human body attribute detection model to obtain a target human body attribute outputted by the human body attribute detection model.

8. An electronic device, comprising:
a processor; and
a memory communicatively connected to the processor; wherein
the memory is configured to store instructions executable by the processor, and the processor is configured to execute the instructions to:
acquire a plurality of sample images respectively corresponding to a plurality of human body attribute categories;
detect the plurality of sample images respectively to obtain a plurality of positive sample sub-images and a plurality of negative sample sub-images respectively corresponding to the plurality of human body attribute categories;
determine a plurality of first annotation attributes respectively corresponding to the plurality of positive sample sub-images according to the plurality of human body attribute categories;
determine a plurality of second annotation attributes respectively corresponding to the plurality of negative sample sub-images according to the plurality of human body attribute categories; and
train an initial artificial intelligence model according to the plurality of positive sample sub-images, the plurality of negative sample sub-images, the plurality of first annotation attributes and the plurality of second annotation attributes to obtain the human body attribute detection model.

9. The device according to claim 8, wherein the processor is configured to execute the instructions to:
generate a plurality of positive sample feature maps respectively corresponding to the plurality of positive sample sub-images;
use an attention mechanism to process the plurality of positive sample feature maps to obtain a plurality of first weight features respectively corresponding to the plurality of positive sample feature maps, the first weight feature being configured to describe relative importance of image regions at key locations in the positive sample feature maps.

10. The device according to claim 9, wherein the processor is configured to execute the instructions to:
generate a plurality of negative sample feature maps respectively corresponding to the plurality of negative sample sub-images;
use an attention mechanism to process the plurality of negative sample feature maps to obtain a plurality of second weight features respectively corresponding to the plurality of negative sample feature maps, the second weight feature being configured to describe relative importance of image regions at key locations in the negative sample feature maps.

11. The device according to claim 10, wherein the processor is configured to execute the instructions to:
input the plurality of positive sample sub-images, the plurality of negative sample sub-images, the plurality of first weight features and the plurality of second weight features into the initial artificial intelligence model;
train the artificial intelligence model according to a plurality of first prediction attributes and a plurality of second prediction attributes outputted by the artificial intelligence model, the plurality of first annotation attributes and the plurality of second annotation attributes;
wherein the first prediction attribute is obtained by prediction by the artificial intelligence model according to the positive sample sub-image and the corresponding first weight feature, and the second prediction attribute is obtained by prediction by the artificial intelligence model according to the negative sample sub-image and the corresponding second weight feature.

12. The device according to claim 11, wherein the processor is configured to execute the instructions to:
determine a plurality of first loss values between the plurality of first prediction attributes and the corresponding plurality of first annotation attributes;
determine a plurality of second loss values between the plurality of second prediction attributes and the corresponding plurality of second annotation attributes;
use the artificial intelligence model obtained by training as the human body attribute detection model in response to the plurality of first loss values and the plurality of second loss values satisfying a set condition.

13. The device according to claim 8, wherein the processor is configured to execute the instructions to:
use the Hungarian algorithm to detect the plurality of sample images respectively, so as to obtain a plurality of positive sample detection frames and a plurality of negative sample detection frames respectively corresponding to the plurality of sample images;
use images covered by the plurality of positive sample detection frames respectively as the plurality of positive sample sub-images, and using images covered by the plurality of negative sample detection frames respectively as the plurality of negative sample sub-images.

14. The device according to claim 8, wherein the processor is configured to execute the instructions to:
acquire an image of the human body to be detected;
input the image of the human body to be detected into the human body attribute detection model obtained to obtain a target human body attribute outputted by the human body attribute detection model.

15. A non-transitory computer-readable storage medium storing computer instructions, wherein the computer instructions are configured to cause a computer to execute a training method for a human body attribute detection model, the method comprising:
acquiring a plurality of sample images respectively corresponding to a plurality of human body attribute categories;
detecting the plurality of sample images respectively to obtain a plurality of positive sample sub-images and a plurality of negative sample sub-images respectively corresponding to the plurality of human body attribute categories;
determining a plurality of first annotation attributes respectively corresponding to the plurality of positive sample sub-images according to the plurality of human body attribute categories;
determining a plurality of second annotation attributes respectively corresponding to the plurality of negative sample sub-images according to the plurality of human body attribute categories; and
training an initial artificial intelligence model according to the plurality of positive sample sub-images, the plurality of negative sample sub-images, the plurality of first annotation attributes and the plurality of second annotation attributes to obtain the human body attribute detection model.

16. The device according to claim 15, wherein after the determining the plurality of first annotation attributes respectively corresponding to the plurality of positive sample sub-images according to the plurality of human body attribute categories, the method further comprises:
generating a plurality of positive sample feature maps respectively corresponding to the plurality of positive sample sub-images;
using an attention mechanism to process the plurality of positive sample feature maps to obtain a plurality of first weight features respectively corresponding to the plurality of positive sample feature maps, the first weight feature being configured to describe relative importance of image regions at key locations in the positive sample feature maps.

17. The device according to claim 16, wherein after the determining the plurality of second annotation attributes respectively corresponding to the plurality of negative sample sub-images according to the plurality of human body attribute categories, the method further comprises:
generating a plurality of negative sample feature maps respectively corresponding to the plurality of negative sample sub-images;
using an attention mechanism to process the plurality of negative sample feature maps to obtain a plurality of second weight features respectively corresponding to the plurality of negative sample feature maps, the second weight feature being configured to describe relative importance of image regions at key locations in the negative sample feature maps.

18. The device according to claim 17, wherein the training the artificial intelligence model according to the plurality of positive sample sub-images, the plurality of negative sample sub-images, the plurality of first annotation attributes and the plurality of second annotation attributes to obtain the human body attribute detection model comprises:
inputting the plurality of positive sample sub-images, the plurality of negative sample sub-images, the plurality of first weight features and the plurality of second weight features into the initial artificial intelligence model;
training the artificial intelligence model according to a plurality of first prediction attributes and a plurality of second prediction attributes outputted by the artificial intelligence model, the plurality of first annotation attributes and the plurality of second annotation attributes;
wherein the first prediction attribute is obtained by prediction by the artificial intelligence model according to the positive sample sub-image and the corresponding first weight feature, and the second prediction attribute is obtained by prediction by the artificial intelligence model according to the negative sample sub-image and the corresponding second weight feature.

19. The device according to claim 18, wherein the training the artificial intelligence model according to the plurality of first prediction attributes and the plurality of second prediction attributes outputted by the artificial intelligence model, the plurality of first annotation attributes and the plurality of second annotation attributes comprises:
determining a plurality of first loss values between the plurality of first prediction attributes and the corresponding plurality of first annotation attributes;
determining a plurality of second loss values between the plurality of second prediction attributes and the corresponding plurality of second annotation attributes;
using the artificial intelligence model obtained by training as the human body attribute detection model in response to the plurality of first loss values and the plurality of second loss values satisfying a set condition.

20. The device according to claim 15, wherein the detecting the plurality of sample images respectively to obtain the plurality of positive sample sub-images and the plurality of negative sample sub-images respectively corresponding to the plurality of human body attribute categories comprises:
using the Hungarian algorithm to detect the plurality of sample images respectively, so as to obtain a plurality of positive sample detection frames and a plurality of negative sample detection frames respectively corresponding to the plurality of sample images;
using images covered by the plurality of positive sample detection frames respectively as the plurality of positive sample sub-images, and using images covered by the plurality of negative sample detection frames respectively as the plurality of negative sample sub-images.
